(19) United States
(12) Patent Application Publication
(10) Pub. No.: US 2009/0257874 A1
(43) Pub. Date: Oct. 15, 2009

(54) Vertical axis windmill with weather vane positioning

(76) Inventor: Karl Marvin Rice, Young America, MN (US)

Correspondence Address: Karl M. Rice, 318 Oak Drive, Young America, MN, 55397, US

(21) Appl. No.: 12/082,459

(22) Filed: Apr. 11, 2008

(51) Int. Cl. F03D 7/06; F03D 3/00

(52) U.S. Cl. 416/9; 416/61; 416/142

(57) ABSTRACT

Large flat blades are put on the ends of long lever arms to maximize the torque produced at a central vertical shaft. Pivoting each blade on its own axis allows it to be positioned to best advantage as it rotates around the central vertical shaft. The positioning is accomplished by gearing the blade to a central control gear. By simply attaching a weather vane to the central control gear, the direction of the entire windmill is controlled.

This application claims priority of Provisional Patent Application No. 60/925,824 filed on Apr. 23, 2007

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

What is the best way to harness the energy of the wind? To gather much energy you need sails or blades with large surface area. With most horizontal axis type windmills the blades are laid out as some part of a circle. As it goes around, the inner edge has much less distance to travel per revolution than the outer edge. As you try to add surface area this will lead to an “over-run” problem where the outer edge of the blade is actually trying to push the wind faster than it is going. So instead of collecting energy the outer edge is dissipating part of the energy that the middle and inner side of the blade is collecting. The pitch of the blade can be changed which helps this problem somewhat, but then the efficiency of collecting energy is also sacrificed.

Horizontal axis windmills also require a tower structure to hold them up and become very vulnerable in high winds. The vertical axis designs I have looked at, either still have an over-run problem or have sacrificed surface area to remain omni-directional greatly limiting the energy that can be collected.

### BRIEF SUMMARY OF THE INVENTION

Large flat blades are put on the ends of long lever arms to maximize the torque produced at a central vertical shaft. Pivoting each blade on its own axis allows it to be positioned to best advantage as it rotates around the central vertical shaft. The positioning is accomplished by gearing the blade to a central control gear. By simply attaching a weather vane to the central control gear, the direction of the entire windmill is controlled.

In each revolution, the outer edge of a blade becomes the inner edge of the blade and the inner edge becomes the outer edge, this eliminates the over-run problem almost completely.

The blades are flat and require no special computations to be manufactured.

The gears can be very simple, they just need to preserve a 1:2 gear ratio.

The entire windmill can easily be built on a large enough scale to capture significant energy, for a family living in a windy area.

### BRIEF DESCRIPTION OF THE SEVERAL VIEWS OF THE DRAWING

FIG. 1 depicts the complete assembled windmill.

FIG. 2 shows the main mast: a fixed vertical shaft solidly anchored in the ground.

Features of the main mast include:

2a the fold over point

2b the main thrust bearing (that the frame rests on)

2c the main radial bearing (that the frame rotates around)

2d a fixed spindle (that holds the weather vane)

FIG. 3 is a close up of the fold over point shown before and after folding.

Components of the fold over point include:

3a the sheer pin

3b the breakdown axis bolt

3c the anchor shaft

3d the mast shaft

FIG. 4 shows the frame: the main connecting structure of the windmill. It holds the windmill blades, rotates around the main mast on the main bearings and holds the power pulley of the windmill.

Parts of the frame include:

4a the main tube

4b the power pulley

4c the lower arm

4d support braces

4e windmill blade axis holes

4f the upper arm

4g gear shaft supports

FIG. 5 The windmill blades: the main interface with the wind. They are attached at and rotate on, their own vertical axis. They each have:

5a a blade shaft

5b the blade proper

5c a blade gear

FIG. 6 The positioning assembly: points into the wind. The parts include:

6a the central gear

6b the weather vane

FIG. 7 The gear linkage: linkage that relates the position of the central gear to the gears on the windmill blades. In this example it is simply:

7a a connecting gear to the central gear

7b a connecting gear to the windmill blade

7c a shaft between connecting gears

FIG. 8 Alternate gearing: another way to make a central gear and windmill blade gears.

8a triangular central gear

8b chain drive

8c twice as big triangular blade gear

FIG. 9 Blade positions during a revolution

### DETAILED DESCRIPTION OF THE INVENTION

### Assembling the Machine:

The anchor shaft (3c) is anchored in the ground, checked to be vertical and cemented in place.

The windmill blade proper (5b) is attached to the blade shaft (5a). The gear shaft supports (4g) are attached to the upper arm (4f) of the frame and the connecting gear shafts (7c) are put into their supports. Attach a connecting gear (7a) and (7b) to each end of the connecting gear shafts.

The lower arm (4c) is put on the main tube (4a). The windmill blade shafts (5a) are put through the holes in the lower arm (4e) then they are inserted into the holes in the upper arm (4e). The upper arm (4f) is attached to the main tube (4a). The support braces (4d) are added for rigidity. The power pulley (4b) is attached to the bottom of the main tube (4a) and the frame is complete.

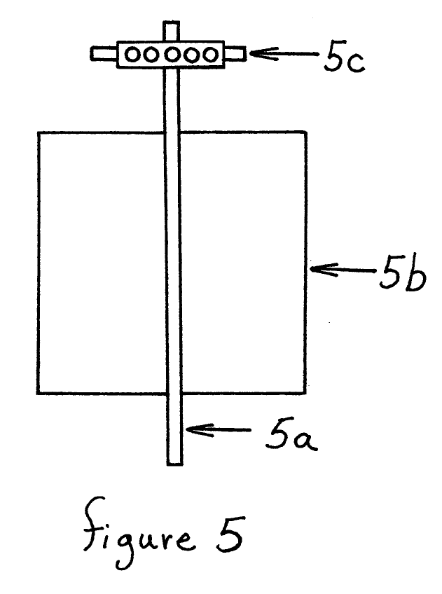

Now attach the blade gears (5c) on top of the blade shafts (5a). Insert the mast shaft (3d) into the frame (FIG. 4). Attach the central gear (6a) to the weather vane (6b).

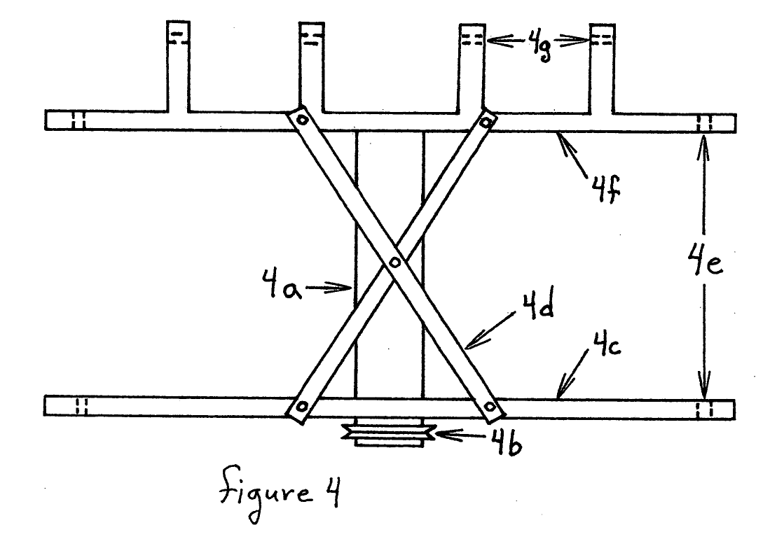

Put the belt for the power pulley on the ground around the anchor shaft. Put mast shaft on anchor mast in the fold down position (FIG. 3) and secure by inserting the breakdown axis bolt.

Put two safety ropes around the lower arm of the frame and stake them into the ground. This is to prevent the windmill from sudden movement when it is erected. Another rope attached to the middle of the upper frame can be very helpful in the next step. Flip the mast shaft up into upright position (FIG. 3) and secure it by inserting a sheer pin.

Thread the belt around the power pulley and generator pulley.

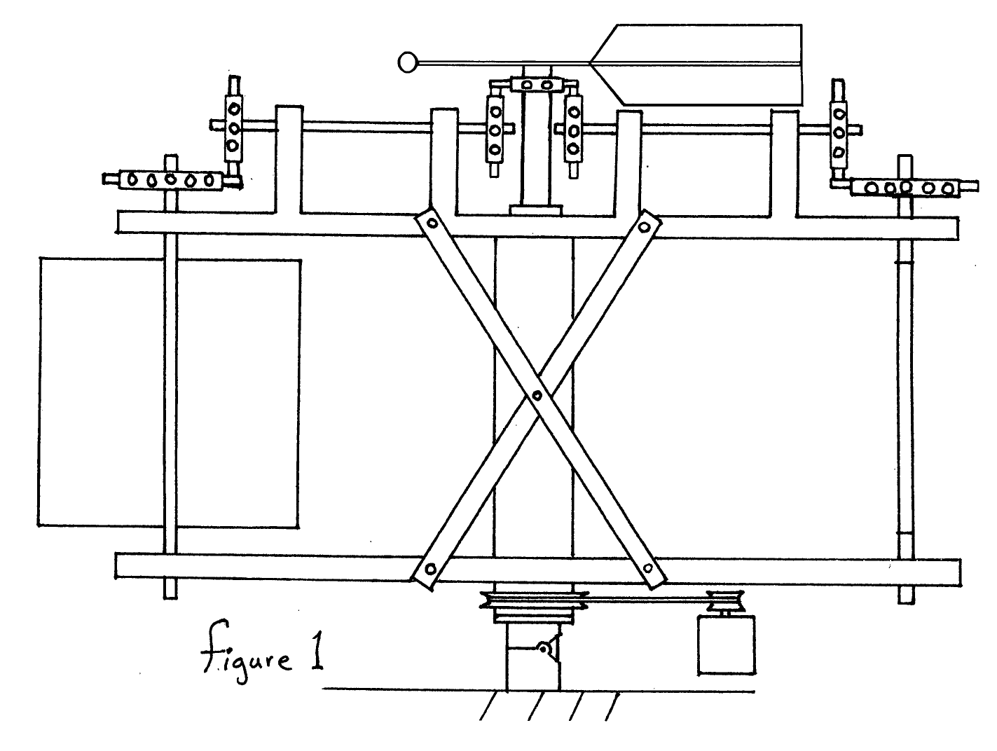

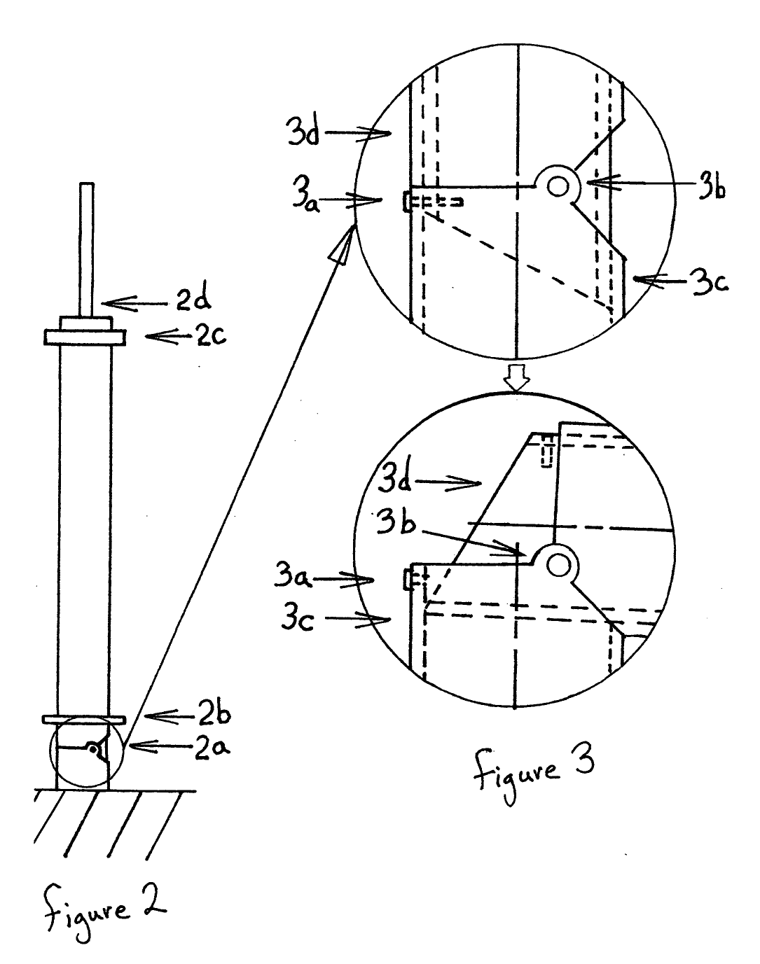

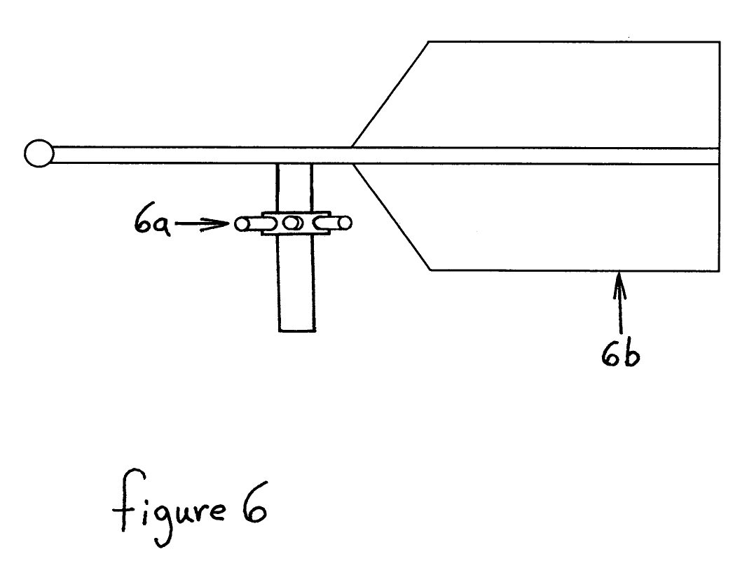

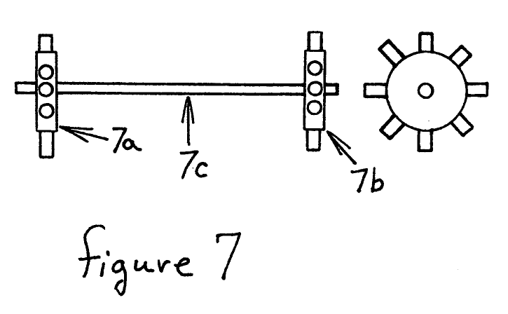

Erect a ladder next to the mast shaft. Climb the ladder and put the positioning assembly (FIG. 6) loosely on the fixed spindle (2d). Before engaging the central gear with the connecting gears you need to position the blades into correct relative positions with respect to the direction that the weather vane is pointing in. The easiest position is similar to (FIG. 1) one blade is radial to the central shaft and flat to the wind, the other blade is 90° degrees to the central shaft which is edge on into the wind and the weather vane also edge on into the wind is parallel to this blade. Not as incorrectly shown in (FIG. 1). So you need to force this position on the blades and the weather vane when you engage the gears. After the gears are engaged the positioning assembly is held in place by a bolt from the top into the fixed spindle that allows it to turn easily but keeps the gears meshed together.

After you remove the ladder and the safety ropes the windmill should point itself into the next wind and begin to work.

### How it Works:

The goal is to produce as much mechanical power in the power take off pulley at the bottom of the frame as possible. To produce torque on the frame at its main tube, windmill blades are placed near the outside end of the long arms (FIG. 1). For each degree of rotation that an arm has as it revolves around the main mast, there is exactly one optimum position for the windmill blade on it's axis that will convert the force on the blade due to the wind into the most torque it can at the main mast (FIG. 9). It turns out that to maintain these optimum positions each blade needs to turn through 180° degrees for every 360° degrees that the arm makes around the main mast. In other words, the blades need to turn halfway around on their own axis every revolution the frame makes on the main mast.

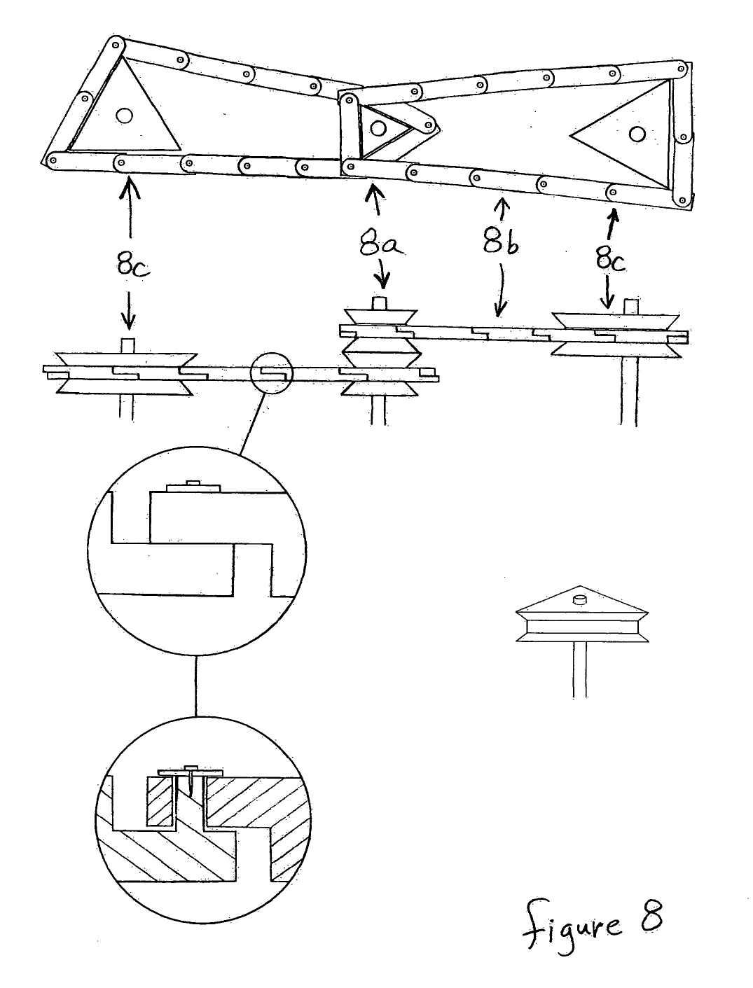

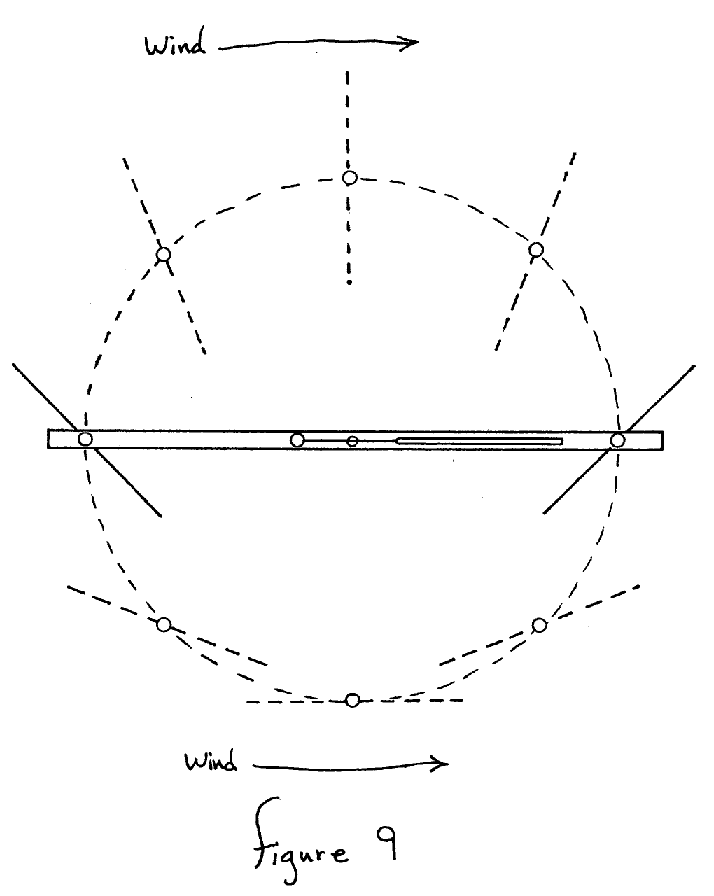

To maintain the correct position on the windmill blades one simply needs a gearing system of exact 1:2 proportions. Where the one gear is mounted on the main mast and a gear with twice the number of teeth or sprockets is mounted on the windmill blade axis. In (FIG. 1) I have drawn simple gears and shafts for clarity but they could be replaced with chains and sprockets like on a bicycle or with simpler chains and triangles like (FIG. 8).

While some vertical shaft windmills don't care which direction the wind is going, this one is very directional and may not even go around if the wind direction is 90° degrees from where it is pointed.

In order to re-position the windmill because of a change in wind direction, you only need to turn the central gear. The blades are geared to it and will turn exactly as they need to. To turn the central gear I have mounted above it, on the same tube, a weather vane. This weather vane does not have to be as big as you might think. First, the blades are mounted on their center axis and have no predisposition to any particular angle into the wind, so it only has to overcome friction and the rotational inertia of the blade. Second, the one to two gear ratio works in favor of the weather vane. So if the weather vane needs to turn 20° degrees the blades only need to turn 10° degrees to catch up.

This design is very good at collecting energy at low wind speeds. It is also in peril when very high wind speeds occur. To minimize damage I have incorporated a sheer pin and emergency fold over place on the main axis (FIG. 3). This allows the windmill to lie nearly flat against the ground and avoid being torn to pieces in damaging winds. This is easy to implement and is a big advantage over windmill designs that require being mounted on a tower and are unable to be folded down.

### Advantages Over Other Designs:

This design can be implemented easily for a very low cost out of ordinary materials. It has no complex aerodynamic shapes to produce.

It requires very few low friction bearing surfaces.

It can fold down for high wind protection.

It incorporates blades with large surface areas on long arms that produce high torques and thus large energy collection capacity in light winds.

The multiple, large area blades and slower rotation will provide good advertising space in addition to energy production.

I claim:

1. A Vertical Axis Windmill design consisting of:
a fixed vertical shaft,
a frame which rotates around the vertical shaft,
a power pulley affixed to the frame,
a center gear (or gears which move as one) which is movable on the vertical shaft,
a weather vane joined to the top of the center gear to hold its position, relative to the wind,
gear linkages that translate the position of the center gear to the blade gears,
wind blades mounted and movable on their own vertical axis each joined to a blade gear.
The gear ratio is 1:2 so that the blade will turn half a revolution on its own axis for each revolution the frame makes around the fixed vertical shaft.

2. The aforementioned windmill (1) with the added refinement of a fold-over point on the fixed vertical shaft so that in untenable winds the windmill folds over and sustains less damage.

3. The aforementioned windmill (1) with the refinement of a small airfoil added to the blade inducing it to turn before being forced by the gearing thus saving wear on the gearing.

4. The aforementioned windmill (1) adapted to work in a river, where the central gear can be fixed since the direction of flow never changes and the power take-off and generator may be mounted on top and anchored by cables to remove them from the water.

5. The aforementioned windmill (1) with the added refinement of an electromechanical device, similar to power steering on a car, to multiply the mechanical advantage of the weather vane so that even a small weather vane could control the central gear on an enormous windmill. Or several small weather vanes could be averaged to control the central gear better.

6. The aforementioned windmill (1) instead of providing power could be driven itself and act as a propeller to push some craft through air or water.
